(19) United States
(12) Patent Application Publication
(10) Pub. No.: US 2026/0149776 A1
(43) Pub. Date: May 28, 2026

(54) INFORMATION PROCESSING SYSTEM AND ELECTRONIC DEVICE

(71) Applicant: KYOCERA Document Solutions Inc., Osaka (JP)

(72) Inventor: Clay Mark SARTE, Osaka (JP)

(73) Assignee: KYOCERA Document Solutions Inc., Osaka (JP)

(21) Appl. No.: 19/401,277

(22) Filed: Nov. 25, 2025

(30) Foreign Application Priority Data
Nov. 26, 2024 (JP) 2024-205808

(51) Int. Cl. H04N 1/00

(52) U.S. Cl. CPC H04N 1/00326; H04N 1/00392; H04N 1/00408; H04N 2201/0094

(57) ABSTRACT

An importing-end electronic device includes a reader, an unmounted state detector, a notifier, and an executer. The reader retrieves device information from an external storage medium. The unmounted state detector decides whether an optional device mounted on an exporting-end electronic device is mounted on the importing-end electronic device, on a basis of mounting status information included in the device information retrieved by the reader, and detects, upon deciding that there is an optional device that is unmounted, the unmounted optional device. The notifier notifies the unmounted optional device, detected by the unmounted state detector, to a user. The executer executes an importing operation, on a basis of the set value data included in the device information retrieved by the reader.

### INCORPORATION BY REFERENCE

This application claims priority to Japanese Patent Application No. 2024-205808 filed on Nov. 26, 2024, the entire contents of which are incorporated by reference herein.

### BACKGROUND

The present disclosure relates to a technique to set a plurality of electronic devices to the same operation format.

Electronic devices such as a printer and a multifunction peripheral are often shared, for example in offices. Accordingly, a plurality of electronic devices are utilized in the same setting. For example, the plurality of electronic devices can be set to the same operation format, by exporting set value data stored in an electronic device serving as the base, specifying the operation format thereof, so that another electronic device can import the set value data.

### SUMMARY

The disclosure proposes further improvement of the foregoing technique.

In an aspect, the disclosure provides an information processing system including an exporting-end electronic device and an importing-end electronic device. The exporting-end electronic device includes a first control device. The first control device includes a processor, and acts as an acquirer, a mounting status detector, and an outputter, when the processor executes a control program. The acquirer acquires set value data to be exported, stored in the exporting-end electronic device. The mounting status detector detects a mounting status of an optional device, on the exporting-end electronic device. The outputter outputs device information, including the set value data acquired by the acquirer, and mounting status information indicating the mounting status of the optional device, detected by the mounting status detector, to an external storage medium. The importing-end electronic device includes a second control device. The second control device includes a processor, and acts as a reader, an unmounted state detector, a notifier, and an executer, when the processor executes a control program. The reader retrieves the device information from the external storage medium. The unmounted state detector decides whether the optional device mounted on the exporting-end electronic device is mounted on the importing-end electronic device, on a basis of the mounting status information included in the device information retrieved by the reader, and detects, upon deciding that there is an optional device that is unmounted, the unmounted optional device. The notifier notifies the unmounted optional device, detected by the unmounted state detector, to a user. The executer executes an importing operation, on a basis of the set value data included in the device information retrieved by the reader.

### BRIEF DESCRIPTION OF THE DRAWINGS

FIG. 1 is a schematic drawing showing the entirety of an information processing system, including image forming apparatuses exemplifying electronic devices according to an embodiment of the disclosure;

FIG. 2 is a functional block diagram schematically showing an essential internal configuration of the image forming apparatus, exemplifying the electronic device according to the embodiment of the disclosure;

FIG. 3 is a flowchart showing an example of an operation performed by a control device of the image forming apparatus;

FIG. 4 is a flowchart showing another example of the operation performed by the control device of the image forming apparatus; and

FIG. 5 is a schematic drawing showing an example of an operation screen displayed on a display device.

### DETAILED DESCRIPTION

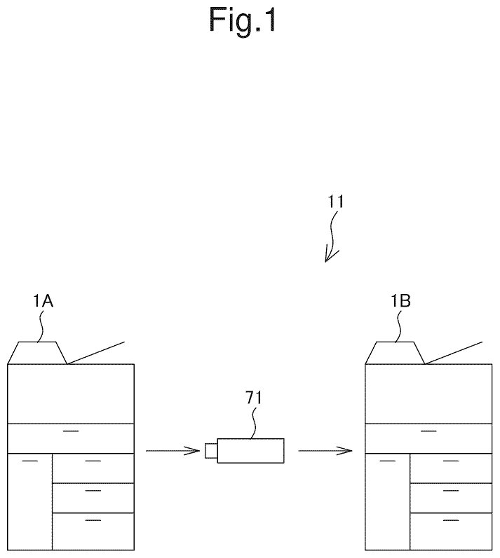

FIG. 1 is a schematic drawing showing the entirety of an information processing system, including image forming apparatuses exemplifying electronic devices according to an embodiment of the disclosure.

The information processing system 11 includes an image forming apparatus 1A acting as an exporting-end electronic device, and an image forming apparatus 1B acting as an importing-end electronic device. The image forming apparatuses 1A and 1B (hereinafter simply “image forming apparatus 1”, where appropriate) are multifunction peripherals having a plurality of functions, such as copying, printing, scanning, and facsimile transmission.

The image forming apparatus 1A outputs set value data, stored therein and to be exported, to an external storage medium such as a universal serial bus (USB) memory 71. The image forming apparatus 1B acquires the set value data, via the USB memory 71.

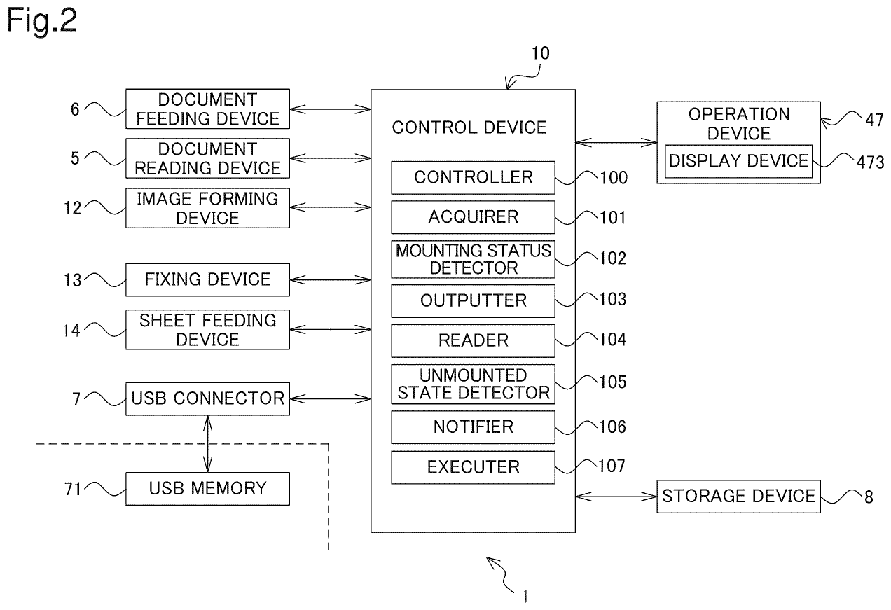

FIG. 2 is a functional block diagram schematically showing an essential internal configuration of the image forming apparatus 1. The image forming apparatus 1 is a multifunction peripheral that can act as both of the exporting-end electronic device and the importing-end electronic device.

The image forming apparatus 1 includes a control device 10, a document feeding device 6, a document reading device 5, an image forming device 12, a fixing device 13, a sheet feeding device 14, an operation device 47, and a storage device 8. The image forming apparatus 1 further includes a USB connector 7, so that a USB memory 71, which is an external storage medium, can be removably attached.

The document feeding device 6 is openably connected to the upper face of the document reading device 5, for example via a non-illustrated hinge. The document feeding device 6 serves as a document retention cover, when a document placed on a non-illustrated platen glass is to be read. The document feeding device 6, generally called an automatic document feeder (ADF), includes a non-illustrated document tray, and feeds the document placed on the document tray to the document reading device 5.

The document reading device 5 includes a scanner, to read the document delivered from the document feeding device 6, or the document placed on the platen glass. The document reading device 5 can also sequentially read a plurality of documents delivered from the document feeding device 6.

To perform the document reading operation, the image forming apparatus 1 operates as follows. The document reading device 5 optically reads the image on the document delivered from the document feeding device 6 to the document reading device 5, or placed on the platen glass, and generates image data. The image data generated by the document reading device 5 is stored, for example, in a non-illustrated image memory.

To perform the image forming operation, the image forming apparatus 1 operates as follows. The image forming device 12 includes a photoconductor drum, a charging device, an exposure device, a developing device, and a primary transfer device for each of the colors, and forms an image on a recording sheet, serving as a recording medium, by secondary transfer via an intermediate transfer belt. The image forming device 12 forms a toner image on the recording sheet delivered from the sheet feeding device 14, thereby producing a printed material, on the basis of the image data generated through the document reading operation, image data stored in the image memory, or image data received from a computer connected via the network.

The fixing device 13 includes a heat roller, a pressure roller, and a drive mechanism therefor, and heats and presses the recording sheet on which the image has been formed by the image forming device 12, at the nip region defined between the mentioned rollers, to thereby fix the image onto the recording sheet. The recording sheet that has undergone the fixing process is delivered to a non-illustrated output tray.

The sheet feeding device 14 includes a non-illustrated sheet cassette, and also includes a pickup roller, transport rollers, a transport route, and rotational drive mechanism for the rollers, for picking up the recording sheet from the sheet cassette and transporting the recording sheet to the image forming device 12.

The operation device 47 includes various hard keys to be operated by the user, and receives the user's instructions inputted with the hard keys, to execute the functions and operations that the image forming apparatus 1 is configured to perform, for example the image forming operation.

The operation device 47 includes a display device 473 for displaying, for example, an operation guide for the user. The operation device 47 receives, through a touch panel provided on the display device 473, the user's instruction based on the touch operation performed by the user on the screen displayed on the display device 473.

The display device 473 includes, for example, a liquid crystal display (LCD). When the user touches a button or a key displayed on the screen, the touch panel receives the instruction corresponding to the touched position. In this case, the touch panel acts as a part of the operation device.

The storage device 8 is a large-capacity storage device such as a hard disk drive (HDD) or a solid-state drive (SSD), and contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 10 includes a controller 100, an acquirer 101, a mounting status detector 102, an outputter 103, a reader 104, an unmounted state detector 105, a notifier 106, and an executer 107.

To be more specific, the control device 10 acts as the controller 100, the acquirer 101, the mounting status detector 102, the outputter 103, the reader 104, the unmounted state detector 105, the notifier 106, and the executer 107, when the processor operates according to the control program stored in the storage device 8. Here, the controller 100 and other components may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the fixing device 13, the sheet feeding device 14, the operation device 47, the storage device 8, and the USB connector 7, and controls the operation of the mentioned components. The controller 100 also executes some processings required for the image forming operation to be performed by the image forming apparatus 1.

The acquirer 101, the mounting status detector 102, and the outputter 103 are for allowing the image forming apparatus 1 to act as the exporting-end electronic device. The reader 104, the unmounted state detector 105, the notifier 106, and the executer 107 are for allowing the image forming apparatus 1 to act as the importing-end electronic device.

The acquirer 101 acquires set value data to be exported, stored in the storage device 8. The storage device 8 contains the setting data with respect to each of the functions that the image forming apparatus 1A is configured to perform. The setting data includes the setting data with respect to each of optional devices provided for the image forming apparatus 1A. The setting data contains the set values specifying the operation format of the image forming apparatus 1A and the optional devices.

For example, the acquirer 101 acquires the set value data specifying the operation detail in a category designated by a selection instruction inputted by the user through the operation device 47, from the storage device 8.

The mounting status detector 102 detects the mounting status of the optional devices (e.g., an additional sheet cassette, an additional tray, and a FAX board), on the image forming apparatus 1 (image forming apparatus 1A acting as the exporting-end electronic device). For example, the mounting status detector 102 transmits a confirmation signal to an interface device to which the optional device may be mounted, and recognizes the mounting status of the corresponding optional device, depending on whether the response to the confirmation signal is received.

The outputter 103 outputs device information, including the set value data acquired by the acquirer 101, and mounting status information indicating the mounting status of the optional device, detected by the mounting status detector 102, to the external storage medium. For example, the outputter 103 converts the device information to the XML format, which has high versatility, and outputs the converted device information to the USB memory 71, via the USB connector 7.

The reader 104 retrieves the device information, from the external storage medium. For example, the reader 104 retrieves the device information from the USB memory 71, via the USB connector 7.

The unmounted state detector 105 decides whether all of the optional devices mounted on the exporting-end electronic device (image forming apparatus 1A), indicated by the mounting status information included in the device information retrieved by the reader 104, are mounted on the image forming apparatus 1 (image forming apparatus 1B acting as the importing-end electronic device), on the basis of the detection result provided by the mounting status detector 102, and detects, upon deciding that any of the optional devices is unmounted, such unmounted optional device. For example, when the mounting status information included in the device information indicates that the FAX board is mounted on the exporting-end electronic device, but the FAX board is not mounted on the importing-end electronic device, the unmounted state detector 105 detects the FAX board as the unmounted optional device.

The notifier 106 notifies the unmounted optional device detected by the unmounted state detector 105, to the user. For example, the notifier 106 controls the displaying operation of the display device 473, so as to display the unmounted optional device, on the display device 473. Accordingly, the user can be made aware that there is an optional device that is unmounted, about which the setting data is unable to be imported, on the image forming apparatus 1B acting as the importing-end electronic device.

The executer 107 executes the importing operation, using the set value data included in the device information retrieved by the reader 104. For example, the executer 107 executes a preliminary process for deciding whether the importing operation can be normally executed, with respect to each of the set value data, and stores the set value data in the storage device 8, upon deciding that the importing operation can be normally executed, thereby installing the set value data in the image forming apparatus 1.

In the preliminary process, it is decided whether the set value data is within the capacity of the image forming apparatus 1 (within the range that the capacity of the optional device mounted can accept), and whether the optional device necessary for the importing operation based on the set value data is mounted on the image forming apparatus 1. When the set value data is exceeding the capacity of the image forming apparatus 1, and when the optional device, to which the set value data is applied, is not mounted on the image forming apparatus 1 (inclusive of the case where the optional device is unapplicable at all), the executer 107 decides that the importing operation is unable to be normally executed, and keeps from executing the importing operation.

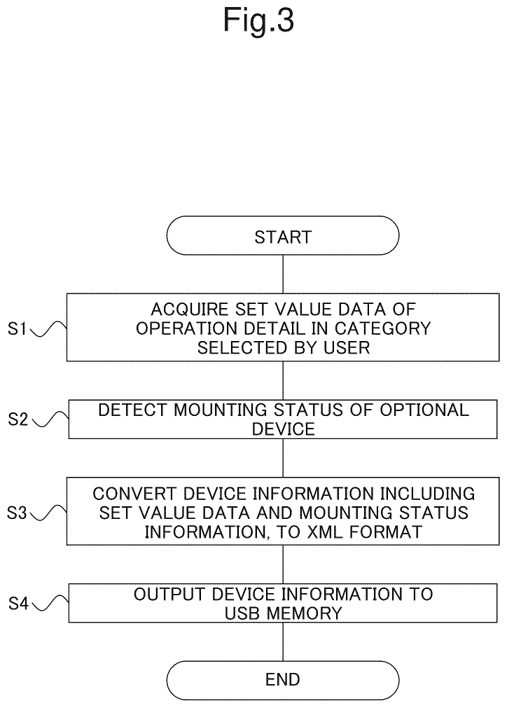

Referring now to a flowchart shown in FIG. 3, an example of the exporting operation, performed by the image forming apparatus 1 acting as the exporting-end electronic device, will be described hereunder. This operation is performed when the user inputs the instruction to execute the exporting operation, and the instruction for selecting the category, through the operation device 47, in a maintenance mode.

The acquirer 101 acquires the set value data specifying the operation detail in the category designated by the selection instruction inputted through the operation device 47, from the storage device 8 (S1). The mounting status detector 102 detects the mounting status of the optional device, on the image forming apparatus 1 (S2).

Then the outputter 103 converts the device information, including the set value data acquired by the acquirer 101, and the mounting status information indicating the mounting status of the optional device, detected by the mounting status detector 102, into the XML format (S3), and outputs the device information to the USB memory 71, via the USB connector 7 (S4). Thereafter, the exporting operation is finished.

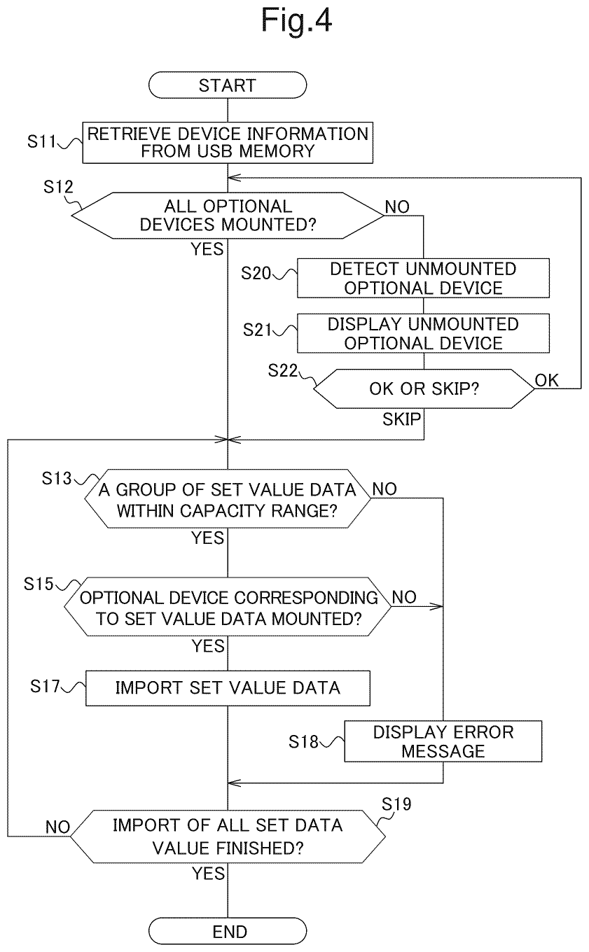

Referring to a flowchart shown in FIG. 4, an example of the importing operation, performed by the image forming apparatus 1 acting as the importing-end electronic device, will be described hereunder. This operation is performed when the user inputs the instruction to execute the importing operation through the operation device 47, in the maintenance mode. It is assumed here that the user has inserted the USB memory 71 containing the device information, to the USB connector 7 of the image forming apparatus 1 acting as the importing-end electronic device.

The reader 104 retrieves the device information from the USB memory 71, via the USB connector 7 (S11). The unmounted state detector 105 analyzes the device information (set value data and mounting status information) retrieved by the reader 104, and decides whether all of the optional devices mounted on the exporting-end electronic device (image forming apparatus 1A), indicated by the mounting status information included in the device information, are mounted on the image forming apparatus 1 (image forming apparatus 1B acting as the importing-end electronic device), on the basis of the detection result provided by the mounting status detector 102 (S12). In other words, the unmounted state detector 105 decides whether any of the optional devices, indicated by the mounting status information, is unmounted on the importing-end electronic device.

When the unmounted state detector 105 decides that there is no unmounted optional device, in other words that all of the optional devices indicated by the mounting status information included in the device information are mounted (YES at S12), the executer 107 decides, with respect to one group of the set value data included in the device information, whether the values indicated by the set value data are within the range that the capacity of the optional device, to which the set value data is applied, can accept (S13).

Upon deciding that the values indicated by the set value data are beyond the range that the capacity of the optional device to which the set value data is applied can accept (NO at S13), the executer 107 controls the displaying operation of the display device 473, so as to display an error message indicating that the importing operation is unable to be normally executed, with respect to the corresponding optional device (S18). Then the operation proceeds to S19.

In contrast, upon deciding that the values indicated by the set value data are within the range that the capacity of the optional device to which the set value data is applied can accept (YES at S13), the executer 107 decides whether the optional device, to which the set value data is applied, is mounted on the image forming apparatus 1 (image forming apparatus 1B acting as the importing-end electronic device) (S15). This decision includes deciding whether the image forming apparatus 1 has the function to enable the optional device to be mounted, and whether, in the affirmative case, the optional device is actually mounted. Whether the image forming apparatus 1B has the function to enable the optional device to be mounted means whether, when the optional device to which the set value data is applied is mounted, the image forming apparatus 1B has the function to cause the optional device to operate. For example, when the FAX board is mounted on the image forming apparatus 1A acting as the exporting-end electronic device, and the mounting status information included in the device information indicates to this effect, but the FAX board is not mounted on the image forming apparatus 1B acting as the importing-end electronic device, the executer 107 decides that the image forming apparatus 1B does not have the function to enable the optional device to be mounted. Thus, the case where the executer 107 decides that the image forming apparatus 1B does not have the function to enable the optional device to be mounted, is also included in the decision that the optional device to which the set value data is applied is not mounted on the image forming apparatus 1B.

Upon deciding, with respect to the one group of the set value data included in the device information, that the optional device to which the set value data is applied is mounted on the image forming apparatus 1B (YES at S15), the executer 107 executes the importing operation, by specifying the set value data with respect to the corresponding optional device (S17).

In contrast, upon deciding that the image forming apparatus 1B does not have the function to enable the optional device to be mounted (NO at S15), the executer 107 controls the displaying operation of the display device 473, so as to display the error message indicating that the importing operation is unable to be normally executed, with respect to the corresponding optional device (S18). Then the operation proceeds to S19.

After the importing operation with respect to the one group of the set value data (S17), or after S18, the executer 107 decides whether the importing operation, with respect to the optional devices to which all the set value data included in the device information is to be applied, has finished (S19). When the executer 107 decides that the importing operation, with respect to the optional devices to which all the set value data included in the device information is to be applied, has finished (YES at S19), the importing operation is finished. In contrast, when the executer 107 decides that the importing operation, with respect to the optional devices to which all the set value data included in the device information is to be applied, has not finished (NO at S19), the operation returns to S13, to execute the importing operation with respect to the optional device to which another group of the set value data is to be applied.

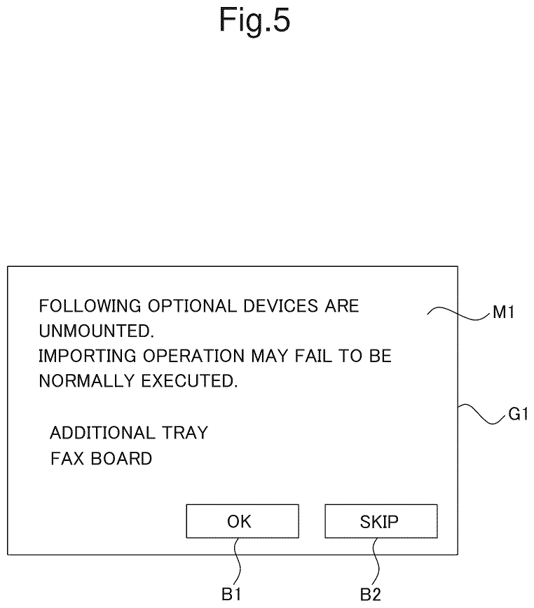

Here, when the unmounted state detector 105 decides at S12 that there is at least one optional device that is unmounted, in other words that at least one of the optional devices, indicated by the mounting status information included in the device information, is unmounted (NO at S12), the unmounted state detector 105 identifies the unmounted optional device (S20). Thereafter, the notifier 106 controls the displaying operation of the display device 473, so as to display message indicating the unmounted optional device, as shown in FIG. 5 (S21). FIG. 5 illustrates an example of an operation screen G1 displayed on the display device 473.

The operation screen G1 includes a message M1 indicating that the additional tray and the FAX board are unmounted, and urging the user to mount the displayed optional devices, and an operation button B1 marked as “OK” and an operation button B2 marked as “Skip”.

When the operation device 47 receives a reexecution instruction, inputted by a press of the operation button B1 marked as “OK” (OK at S22), the unmounted state detector 105 executes the operation of S12 again. For example, when the user mounts the optional devices cited as unmounted, on the image forming apparatus 1 (image forming apparatus 1B acting as the importing-end electronic device), and then presses the operation button B1 marked as “OK”, the reexecution instruction is inputted.

In contrast, when the operation device 47 receives a cancel instruction, inputted by a press of the operation button B2 marked as “Skip” (Skip at S22), the operation proceeds to S15. In this case, the importing operation is executed only with respect to the optional devices, to which the importing operation is applicable through S13 and subsequent steps. In this case, “NO” is selected at S15, with respect to the unmounted optional device.

According to the foregoing embodiment, the optional device, mounted on the image forming apparatus 1A acting as the exporting-end electronic device, but unmounted on the image forming apparatus 1B acting as the importing-end electronic device is notified to the user, and therefore the user is given the opportunity to correct the discordance in mounting status of the optional device. Accordingly, a failure in importing operation on the side of the importing-end electronic device can be avoided, when the set value data in the exporting-end electronic device is to be imported by the importing-end electronic device.

In the case of existing electronic devices, not configured according to the foregoing embodiment, the importing operation may result in a failure, when the importing operation is executed by an electronic device (importing-end electronic device), on the basis of the set value data (import data) in another electronic device (exporting-end electronic device) serving as the base.

The mentioned failure primarily arises from the following two situations. One is the case where the set value data in the exporting-end electronic device is beyond the capacity of the importing-end electronic device. The other is the case where the optional devices (e.g., the additional sheet cassette, the additional tray, and the FAX board) mounted on the exporting-end electronic device, are not mounted on the importing-end electronic device, and the discordance in mounting status of the optional device is

### Incurred.

According to the foregoing embodiment, in contrast, the failure in importing operation on the side of the importing-end electronic device can be avoided, when the set value data in the exporting-end electronic device is to be imported by the importing-end electronic device.

The disclosure may be modified in various manners, without limitation to the foregoing embodiment. Further, the configurations and processings according to the embodiment, described with reference to FIG. 1 to FIG. 5, are merely exemplary, and in no way intended to limit the disclosure to those configurations and processings.

While the present disclosure has been described in detail with reference to the embodiments thereof, it would be apparent to those skilled in the art that the various changes and modifications may be made therein within the scope defined by the appended claims.

What is claimed is:

1. An information processing system comprising:
an exporting-end electronic device; and
an importing-end electronic device,
the exporting-end electronic device including a first control device including a processor, and configured to act, when the processor executes a control program, as:
an acquirer that acquires set value data to be exported, stored in the exporting-end electronic device;
a mounting status detector that detects a mounting status of an optional device, on the exporting-end electronic device; and
an outputter that outputs device information, including the set value data acquired by the acquirer, and mounting status information indicating the mounting status of the optional device, detected by the mounting status detector, to an external storage medium,
the importing-end electronic device including a second control device, including a processor, and configured to act, when the processor executes a control program, as:
a reader that retrieves the device information from the external storage medium;
an unmounted state detector that decides whether the optional device mounted on the exporting-end electronic device is mounted on the importing-end electronic device, on a basis of the mounting status information included in the device information retrieved by the reader, and detects, upon deciding that there is an optional device that is unmounted, the unmounted optional device:
a notifier that notifies the unmounted optional device, detected by the unmounted state detector, to a user; and
an executer that executes an importing operation, on a basis of the set value data included in the device information retrieved by the reader.

2. The information processing system according to claim 1,
wherein the importing-end electronic device further includes a display device, and
the executer causes the display device to display, upon deciding that a set value indicated by the set value data, included in the device information, is beyond a range of the set value that capacity of the optional device, to which the set value data is to be applied, can accept, an error message indicating that the importing operation is unable to be normally executed, with respect to the corresponding optional device.

3. An electronic device comprising a first control device, including a processor, and configured to act, when the processor executes a control program, as:
an acquirer that acquires set value data to be exported, stored in the exporting-end electronic device;
a mounting status detector that detects a mounting status of an optional device, on the exporting-end electronic device; and
an outputter that outputs device information, including the set value data acquired by the acquirer, and mounting status information indicating the mounting status of the optional device, detected by the mounting status detector, to an external storage medium.

4. An importing-end electronic device comprising a second control device, including a processor, and configured to act, when the processor executes a control program, as:
a reader that retrieves device information from an external storage medium, containing the device information including set value data stored in another electronic device, and mounting status information indicating a mounting status of one or more optional devices on the other electronic device;
an unmounted state detector that decides whether all of the optional devices mounted on the other electronic device are mounted on the importing-end electronic device, on a basis of the mounting status information included in the device information retrieved by the reader, and detects, upon deciding that there is an optional device that is unmounted, the unmounted optional device:
a notifier that notifies the unmounted optional device, detected by the unmounted state detector, to a user; and
an executer that executes an importing operation, on a basis of the set value data included in the device information retrieved by the reader.

5. The importing-end electronic device according to claim 4,
wherein the executer keeps from executing the importing operation, when the unmounted state detector decides that there is at least one optional device that is unmounted.

6. The importing-end electronic device according to claim 5, further comprising an operation device that receives an input of an instruction from the user,
wherein the executer executes the importing operation, provided that the operation device receives the instruction from the user to forcibly execute the importing operation, despite the unmounted state detector having decided that there is at least one optional device that is unmounted.
